(19) United States
(12) Patent Application Publication
(10) Pub. No.: US 2025/0246867 A1
(43) Pub. Date: Jul. 31, 2025

(54) LASER PUMPING DEVICE WITH PUMP LIGHT GUIDED BY COOLING LIQUID

(71) Applicant: LEDIas Corp., Hsinchu City (TW)

(72) Inventor: Yen-Chieh HUANG, Hsinchu (TW)

(21) Appl. No.: 18/422,573

(22) Filed: Jan. 25, 2024

(51) Int. Cl. H01S 3/0933; H01S 3/04; H01S 3/06

(52) U.S. Cl. CPC H01S 3/0933; H01S 3/0407; H01S 3/061

(57) ABSTRACT

A laser pumping device includes a pump-light emitter, a dielectric tube and a laser gain material. The pump-light emitter is configured to emit a pump light and has a pump axis. The dielectric tube is hollow-shaped and includes an accommodation space, an entrance surface and a plurality of reflection surfaces. The pump-light emitter is disposed adjacent to the entrance surface. The laser gain material is installed in the accommodation space filled with cooling water. The dielectric tube is configured to receive the pump light into the entrance surface, guide the pump light along the pump axis surrounded by the reflection surfaces, and concentrate the pump light into the laser gain material. The cooling water has dual purposes, including guiding the pump light toward and removing the heat from the laser gain material.

### BACKGROUND

### Technical Field

The present disclosure relates to a scheme of a laser pumping device and, in particular, to one that may utilize dielectric-confined cooling liquid to concentrate light to pump a laser rod and at the same time remove the heat from the laser rod. This disclosure covers both laser oscillators and laser amplifiers operated by adopting such a pumping scheme.

### Description of Related Art

In a typical laser system, atoms are pumped by external energy from a low-energy level to a high-energy level. The falling of a high-energy atom to a low-energy level releases radiation energy to form the basis of laser emission. For example, energy levels E0, E1, E2, and E3 are represented a sequence of ascending energy levels in a typical 4-level atomic system such as that in an Nd laser. Initially, the atoms are populated at the ground-state energy level E0. An external pump light drives the ground-level atoms from E0 to E3. The atoms quickly drop down from E3 to a slightly lower energy level E2 with a longer lifetime to achieve popular inversion of atoms between E2 and E1 for laser emission. When the atoms drop from E3 to E2, the waste energy heats up the laser crystal and could bring the atoms from E0 to E1 and destroy the population inversion, which is necessary for laser action. Therefore, removing heat from a laser crystal is crucial for building a laser.

In practice, to be efficient, the pump light must be concentrated to a laser gain medium, which is usually a rod with a small aperture diameter for the laser to emit along the rod axis. In the prior arts, for a pump light that is not focusable, a glass wedge guide is often used to concentrate the pump light toward a laser rod installed in a glass tube with cooling water. The water in the glass tube removes the heat from the laser crystal. In such a laser-pumping structure, the glass wedges are delicate and expensive to make. Furthermore, the thickness of the water-tube wall between the wedge output and the laser rod prevents the pump light from reaching the laser rod quickly for efficient laser pumping. Any unnecessary interface between the quickly diverging pump light and the laser rod reduces the amount of pump light to reach the laser rod and thereby decrease the pump efficiency.

Given the drawbacks in the prior arts, there is a practical need to invent an effective and efficient laser pumping device, in which guiding and concentrating the pump light are considered together with the removal of the heat from the laser rod.

### SUMMARY

According to one aspect of the present disclosure, a laser pumping device includes a pump-light emitter, a dielectric tube, and a laser gain material. The pump-light emitter is configured to emit a pump light and has a pump axis. The dielectric tube is hollow-shaped and includes an accommodation space, which may be filled with a cooling liquid, an entrance surface, and a plurality of reflection surfaces. The pump-light emitter is disposed adjacent to the entrance surface. The laser gain material is installed in the accommodation space. The dielectric tube may be filled with the cooling liquid and is configured to receive the pump light into the entrance surface, guide the pump light along the pump axis surrounded by the reflection surfaces, and transmit the pump light into the laser gain material.

According to another aspect of the present disclosure, a laser pumping device includes a plurality of pump-light emitters, a tube structure, and a laser gain material. Each of the pump-light emitters is configured to emit a pump light and has a pump axis. The tube structure is hollow-shaped and includes at least one accommodation space and at least one dielectric tube. The dielectric tube includes at least one entrance surface and a plurality of reflection surfaces. A number of the pump-light emitters and a number of the at least one entrance surface are plural and the same, and each of the pump-light emitters is disposed adjacent to a corresponding one of the entrance surfaces. The laser gain material is installed in the accommodation space, which may be filled with a cooling liquid. The dielectric tube may be filled with the cooling liquid and is configured to receive at least one of the pump lights into the corresponding entrance surface, guide the pump light along a corresponding one of the pump axes surrounded by the reflection surfaces, and concentrate the pump light into the laser gain material.

### BRIEF DESCRIPTION OF THE DRAWINGS

The present disclosure can be understood by reading the following detailed description of the embodiment, with reference made to the accompanying drawings as follows:

FIG. 1A is a schematic view of the theory backing up the present disclosure.

FIG. 1B is another schematic view of the theory backing up the present disclosure.

FIG. 2 is a schematic view of a laser pumping device according to the 1st embodiment of the present disclosure.

FIG. 3 is a schematic view of a laser pumping device according to the 2nd embodiment of the present disclosure.

FIG. 4 is a schematic view of a laser pumping device according to the 3rd embodiment of the present disclosure.

FIG. 5 is a schematic view of a laser pumping device according to the 4th embodiment of the present disclosure.

### DETAILED DESCRIPTION

Embodiments of the present disclosure will be described below with reference to the drawings. For the sake of clarity, many practical details will be explained together in the following statements. However, it should be understood that these practical details should not be used to limit the present disclosure. That is, these practical details are not necessary in embodiments of the present disclosure. In addition, for the sake of simplifying the drawings, some commonly used structures and components are shown in the drawings in a simple schematic manner; and repeated components may be represented by the same numbers.

Moreover, the combination of components in the present disclosure is not a combination that is generally known, conventional or customary in this field. The components themselves being or being not common knowledge cannot be used to determine whether the combination relationship can be easily completed by a person skilled in the technical field.

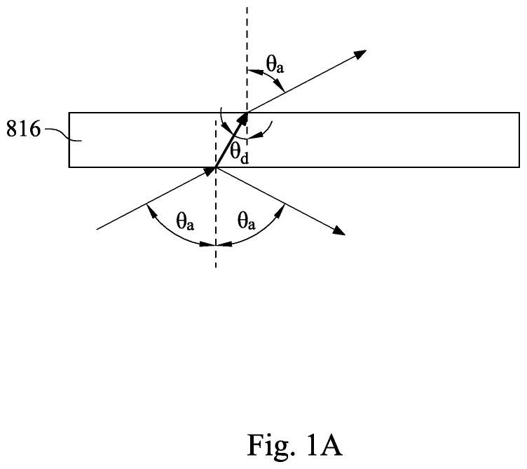

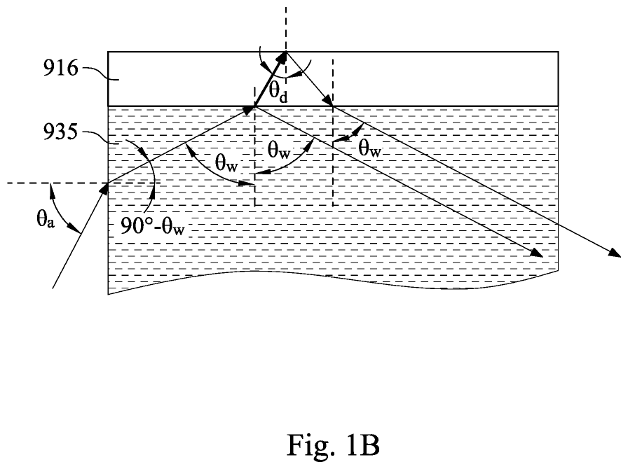

FIG. 1A is a schematic view of the theory backing up the present disclosure. With reference to FIG. 1A, it is supposed that a light ray is incident on a dielectric slab (optical dielectric slab) 816 at an angle of θₐ from the air environment. At the material interfaces, part of the energy of the incident light ray is reflected at an angle of θₐ, part of the energy of the incident light ray is refracted into the dielectric slab with an angle of Od, and part of the refracted light ray is transmitted through the dielectric slab with an angle of θₐ. The angles θₐ, θ_{d} of the light rays in the dielectric slab 816 are governed by the Snell's law:

$${n}_{a} sin {θ}_{a} = {n}_{d} sin {θ}_{d} . \qquad ( 1 )$$

In Equation (1), nₐ and n_{d} are the refractive indices of air and the dielectric slab 816, respectively. From the geometry, the incident angle of the light ray at the dielectric-air interface is also Od. Therefore, the same Snell's law in Equation (1) applies to obtain the transmitting angle=θₐ for the light going out from the upper surface of the dielectric slab 816. This means that, for the configuration in FIG. 1A, part of the light-way energy is always lost by the transmission of the light ray through the dielectric slab 816.

FIG. 1B is another schematic view of the theory backing up the present disclosure. With reference to FIG. 1B, it is considered now that water 935 is filled under the dielectric slab 916 (may have different refractive index from the dielectric slab 816 in FIG. 1A) and the light right enters from air on the left. At the air-water interface, the Snell's law is written as Equation (2) or Equation (3):

$${n}_{a} sin {θ}_{a} = {n}_{w} sin ( 90 - {θ}_{w} cos {θ}_{w} ; and \qquad ( 2 )$$

$$sin {θ}_{w} = \sqrt{1 - {( \frac{{n}_{a}}{{n}_{w}} sin {θ}_{a} )}^{2}} . \qquad ( 3 )$$

In Equations (2) and (3), n_{w} is the refractive index of water 935 and the angle θ_{w} is the incident angle of the refracted light ray on the water-dielectric interface. At the water-dielectric interface, the Snell's law is written as:

$${n}_{w} sin {θ}_{w} = {n}_{d} sin {θ}_{d} . \qquad ( 4 )$$

Suppose the goal is to force the energy of the light way to return from the dielectric-air interface to the water region. The following Equation (5) is the condition to have total internal reflection of the light ray at the dielectric-air interface:

$$sin {θ}_{d} > \frac{{n}_{a}}{{n}_{d}} . \qquad ( 5 )$$

Substituting both Equations (3) and (5) into Equation (4), one obtains the following Equation (6):

$${n}_{a} sin {θ}_{a} < \sqrt{{n}_{w}^{2} - {n}_{a}^{2}} . \qquad ( 6 )$$

Equation (6) is the condition for all the energy of the light way to come down back to the water side. Equation (6) is known to be the numerical aperture of the optical system in FIG. 1B. Remarkably, the refractive index of the dielectric wall is not present in Equation (6). This means that, as long as the liquid water has a refractive index larger than that of air (the refractive index of air is almost 1), Equation (6) supports a nonzero numerical aperture to enable the total internal reflection at the dielectric-air interface in FIG. 1B. With the refractive indices of air and water 935 equal to 1 and 1.33, respectively, one has the entrance angle θₐ<61.26 degrees for the incident light ray to be confined in water 935 due to the total internal reflection at the dielectric-air interface in FIG. 1B. Therefore, a short conclusion is that, without the water 935, total internal reflection may never occur for a light ray incident on the dielectric slab 816 in FIG. 1A; with the water, total internal reflection at the dielectric-air interface provides an acceptance angular range between 0 degrees and 61 degrees for an incident light ray to be confined in the water region in FIG. 1B.

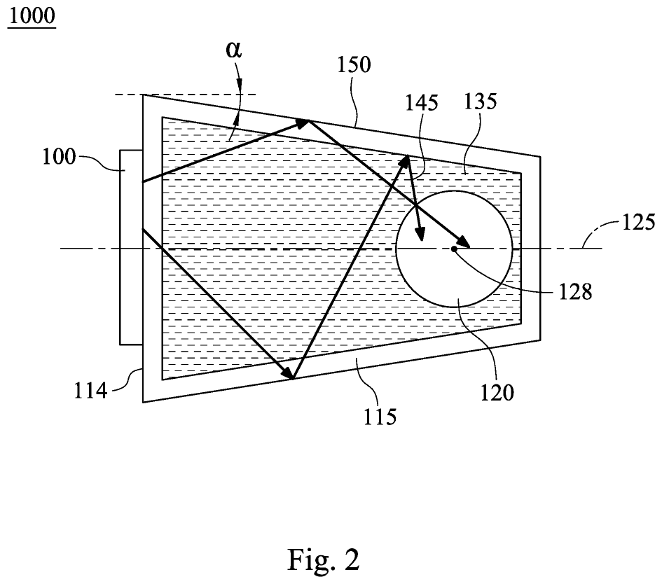

FIG. 2 is a schematic view of a laser pumping device 1000 according to the 1st embodiment of the present disclosure. With reference to FIG. 2, the laser pumping device 1000 includes a pump-light emitter 100, a dielectric tube 115 and a laser gain material 120. The pump-light emitter 100 is configured to emit a pump light 145 and has a pump axis 125. The dielectric tube 115 is hollow-shaped and includes an accommodation space installed with the laser gain material 120 and filled with cooling liquid 135, an entrance surface 114, and a plurality of reflection surfaces 150. The pump-light emitter 100 is disposed adjacent to the entrance surface 114. The dielectric tube 115 is configured to receive the pump light 145 into the entrance surface 114, guide the pump light 145 along the pump axis 125 surrounded by the reflection surfaces 150, and transmit the pump light 145 into the laser gain material 120. Therefore, the dielectric tube 115 of the laser pumping device 1000 is advantageous in design for guiding and concentrating the pump light 145, and at the same time further removing the heat of the laser gain material 120. In addition, the laser gain material 120 may be one among Nd:YAG, Nd:YVO4, Nd:GdVO4, Nd:KGW, Nd:YLF, Nd:glass, Cr:YAG, Cr:LiSAF, Yb:YAG, Yb:glass, Er:YAG, Er:glass, Tm:glass, and Ti:sapphire crystals.

In detail, the pump-light emitter 100 may be an LED plate including arrays of LED dies, and the pump axis 125 is parallel to a normal direction of a surface of the pump-light emitter 100. Specifically, the pump axis 125 of the pump-light emitter 100 serves as the straight line going through the geometric center of the pump-light emitter 100 and along the normal direction of the surface of the pump-light emitter 100. Therefore, the laser pumping device 1000 is beneficial to effectively concentrating the pump light 145 toward the laser gain material 120.

Oppositely faced two of the reflection surfaces 150 may be wedged with a non-zero wedge angle α to concentrate the pump light 145 from the entrance surface 114 with a greater aperture toward the laser gain material 120 in a smaller aperture. Therefore, it is beneficial to further effectively concentrating the pump light 145 on the laser gain material 120. In another embodiment according to the present disclosure, oppositely faced two of the reflection surfaces may be parallel to each other and surround the pump axis.

The laser gain material 120 may be a laser rod and has a rod axis 128 coinciding with the laser emission axis, and the pump axis 125 and the rod axis 128 are transverse to each other, as shown in FIG. 2. The accommodation space may be filled with a liquid 135, an air encloses the dielectric tube 115, and a refractive index of the liquid 135 is greater than a refractive index of the air so that the numerical aperture calculated from Equation (6) has a nonzero value. Therefore, the liquid 135 can be used to guide, confine and concentrate the pump light 145 toward the laser gain material 120 for the laser pumping device 1000.

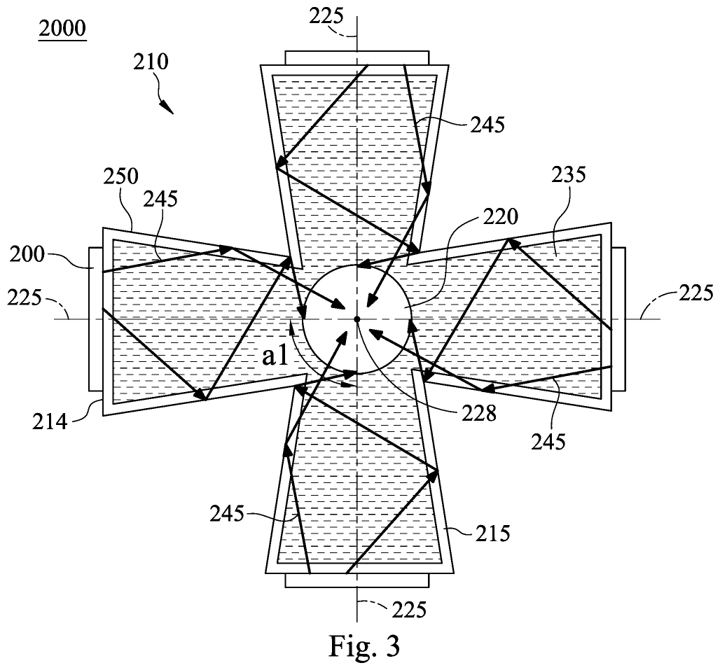

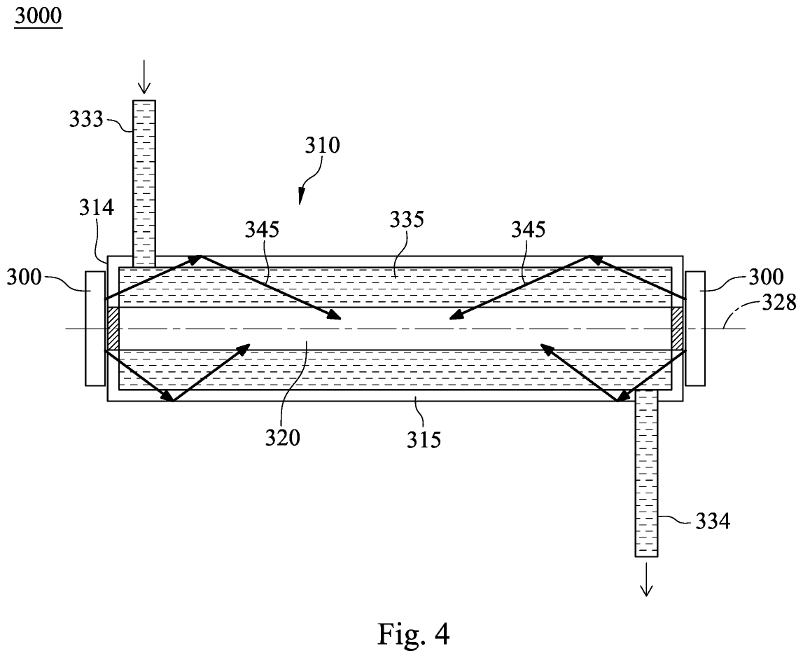

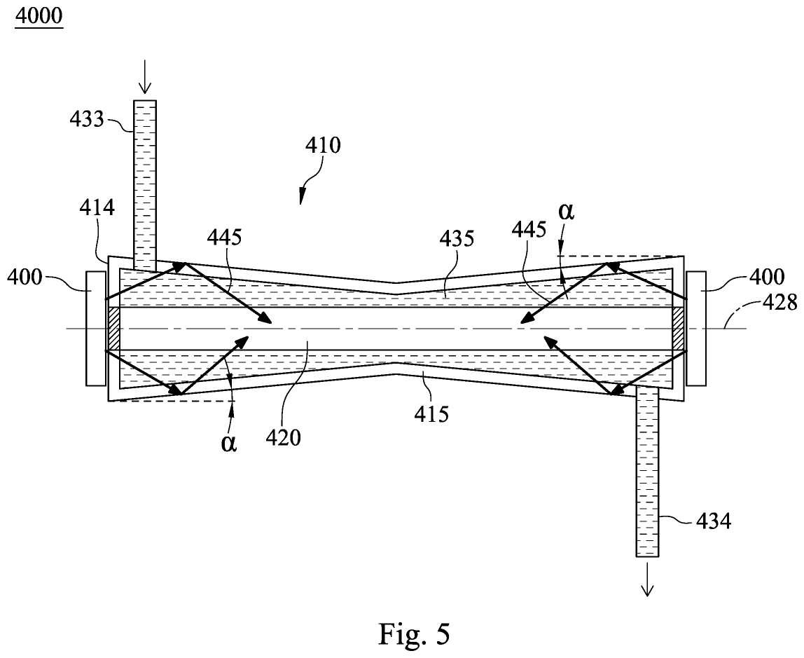

It is noted that, in the drawings (FIG. 2, FIG. 3, FIG. 4 and FIG. 5) of the 1st to 4th embodiments according to the present disclosure, each of the pump lights not bent after being refracted from the liquid-dielectric boundary shows a special case of the refractive index of the liquid very similar to the refractive index of the dielectric tube, because Od is almost the same as Ow in Equation (4).

Each of the reflection surfaces 150 of the dielectric tube 115 at the dielectric-air boundary may provide total internal reflection to the incident pump light 145. Therefore, the liquid 135 is beneficial to guide, confine and concentrate the pump light 145 toward the laser gain material 120.

The liquid 135 may be water, and a material of the dielectric tube 115 may be glass with a refractive index of 1.5. Therefore, the refractive index of the water is 1.33, which is close to the refractive indices of most optical dielectric materials forming the dielectric tubes. This means the pump light 145 incident on and totally reflected from the liquid-dielectric boundary/interface will propagate toward the laser gain material 120. Furthermore, the typical half angle of LED emission is approximately 60 degrees, which is well within the acceptance angle of the glass tube containing water. This means all the LED pump light can be guided by the water-filled dielectric tube 115 to reach the laser gain material 120 for laser pumping. In another embodiment according to the present disclosure, the material of the dielectric tube may be one among glass, quartz, fused silica, and plastic. It is noted that, if the accommodation space is empty or filled with air, the pump light is unguided in the dielectric tube and most of the pump light/light ray can escape from the dielectric-air boundary. It is the purpose of the present disclosure to fill the accommodation space with a liquid to concentrate the pump light toward and remove the heat from the laser gain material.

The pump-light emitter 100 may include a blue, green light or blue-green light LED. Therefore, the water with minimum absorption for blue-green light is advantageous in serving as the liquid 135.

The liquid 135 may be configured to flow in and out the dielectric tube 115 so as to remove a heat generated by the pump-light emitter 100 and the laser gain material 120. Therefore, with the liquid 135 as the cool water in the dielectric tube 115, the pump light 145 is guided toward and pumping the laser gain material 120 via the total internal reflection at the dielectric-air boundary on the reflection surface 150. At the same time, the flow of the liquid 135 circulating in the dielectric tube 115 removes the heat from the laser gain material 120. Thus, the laser pumping device 1000 of the present disclosure provides an effective and powerful scheme to utilize the cooling water for guiding and concentrating the pump light 145 toward the laser gain material 120, and, at the same time, removing the heat of the laser rod immersed in it.

FIG. 3 is a schematic view of a laser pumping device 2000 according to the 2nd embodiment of the present disclosure. With reference to FIG. 3, the laser pumping device 2000 includes a plurality of pump-light emitters 200, a tube structure 210, and a laser gain material 220. Each of the pump-light emitters 200 is configured to emit a pump light 245 and has a pump axis 225. The tube structure 210 is hollow-shaped and includes at least one accommodation space filled with cooling liquid 235 and at least one dielectric tube 215. The dielectric tube 215 includes at least one entrance surface 214 and a plurality of reflection surfaces 250. A number of the pump-light emitters 200 and a number of the at least one entrance surface 214 are plural and the same, and each of the pump-light emitters 200 is disposed adjacent to a corresponding one of the entrance surfaces 214. The laser gain material 220 is installed at the geometric center of the accommodation space. The dielectric tube 215 is configured to receive at least one of the pump lights 245 into the corresponding entrance surface 214, guide the pump light 245 along a corresponding one of the pump axes 225 surrounded by the reflection surfaces 250, and transmit and concentrate the pump light 245 into the laser gain material 220. Therefore, the at least one dielectric tube 215 of the laser pumping device 2000 is advantageous in design for guiding and concentrating the pump lights 245 toward and at the same time further removing the heat from the laser gain material 220.

In detail, the laser gain material 220 is a laser rod and has a rod axis 228 coinciding with the laser emission axis, and each of the pump axes 225 and the rod axis 228 are transverse to each other, as shown in FIG. 3.

Each of a number of the dielectric tube 215, the number of the pump-light emitters 200 and the number of the entrance surfaces 214 may be more than two. Specifically, for the dielectric tubes 215 shown in FIG. 3, the number of the pump-light emitters 200, along with the corresponding entrance surfaces 214, is four, which is not a fixed number for the laser pumping devices of the present disclosure. A person skilled in the art can add or decrease the number subject to a set of specified laser output parameters. In FIG. 3, the dielectric tubes 215 are respectively extended along the four pump axes 225 of the four pump-light emitters 200. The four pump axes 225 intersect in the laser gain material 220.

Each of the pump-light emitters 200 is an LED plate including arrays of LED dies, and each of the pump axes 225 is parallel to a normal direction of a surface of the corresponding pump-light emitter 200. For each of the dielectric tubes 215, oppositely faced two of the reflection surfaces 250 are wedged with a non-zero wedge angle to concentrate the corresponding pump light 245 from the corresponding entrance surface 214 with a greater aperture toward the laser gain material 220 in a smaller aperture.

The accommodation space may be filled with the liquid 235, an air encloses the dielectric tube 215, and a refractive index of the liquid 235 is greater than a refractive index of the air so that the numerical aperture calculated from Equation (6) has a nonzero value. Therefore, the liquid 235 can be used to confine and concentrate the pump lights 245 toward the laser gain material 220 for the laser pumping device 2000. Each of the reflection surfaces 250 located at the air-dielectric boundary can concentrate the pump light 245 toward the laser gain material 220 via total internal reflection subject to a nonzero numerical aperture calculated from Equation (6).

The liquid 235 is specifically flowing water, and a material of the dielectric tubes 215 can be glass or plastic. Each of the pump-light emitters 200 includes a blue or green light LED. The liquid 235 is configured to concentrate the pump lights 245 toward the laser gain material 220, and at the same time remove the heat generated by the pump-light emitters 200 and the laser gain material 220.

FIG. 4 is a schematic view of a laser pumping device 3000 according to the 3rd embodiment of the present disclosure. With reference to FIG. 4, the laser pumping device 3000 includes two pump-light emitters 300, a tube structure 310 and a laser gain material 320. Each of the pump-light emitters 300 is configured to emit a pump light 345 and has a pump axis (coinciding with the rod axis 328). The tube structure 310 is hollow-shaped and includes an accommodation space filled with cooling liquid 335 and two dielectric tubes 315, which are connected to face each other and aligned along the two pump axes. Each of the dielectric tubes 315 includes an entrance surface 314 and a plurality of reflection surfaces 350. The number of the pump-light emitters 300 is two. Each of the pump-light emitters 300 is disposed adjacent to a corresponding entrance surface 314. The laser gain material 320 is installed in the accommodation space. Each of the dielectric tubes 315 is configured to receive the corresponding pump light 345 into the corresponding entrance surface 314, guide the corresponding pump light 345 along a corresponding one of the pump axes surrounded by the reflection surfaces 350, and concentrate the corresponding pump light 345 into the laser gain material 320.

In detail, for each of the dielectric tubes 315, oppositely faced two of the reflection surfaces 350 are parallel to each other and surround the corresponding pump axis. Therefore, it is beneficial to repeatedly reflect the pump lights toward the laser gain material 320 in the laser pumping device 3000.

The laser gain material 320 is a laser rod and has the rod axis 328, and each of the pump axes and the rod axis 328 are parallel to each other. Specifically, the rod axis 328 is the axis coinciding with the two pump axes, as shown in FIG. 4, and the laser pumping device 3000 has a longitudinal-pumping configuration. The number of the entrance surfaces 314 is two, and two ends of the laser gain material 320 is located adjacent to the two entrance surfaces 314, respectively. Specifically, the two pump-light emitters 300 are installed from the opposite ends of the laser gain material 320 to increase the pump absorption by the laser gain material (laser rod) 320.

Each of the pump-light emitters 300 is an LED plate including arrays of LED dies, and each of the pump axes is parallel to a normal direction of a surface of the corresponding pump-light emitter 300.

The accommodation space is filled with the flowing liquid 335, and a liquid inlet 333 and a liquid outlet 334 are connected to the tube structure 310. An air encloses the dielectric tubes 315, and a refractive index of the liquid 335 is greater than a refractive index of the air. Each of the reflection surfaces 350 located at the air-dielectric boundary can concentrate the pump light 345 toward the laser gain material 320 via total internal reflection subject to a nonzero numerical aperture calculated from Equation (6).

The liquid 335 is specifically a water, and a material of the dielectric tubes 315 can be glass or plastic. Each of the pump-light emitters 300 includes a blue or green light LED. The flowing liquid 335 is configured to concentrate the pump light toward the laser gain material 320, and at the same time remove the heat generated by the pump-light emitters 300 and the laser gain material 320.

FIG. 5 is a schematic view of a laser pumping device 4000 according to the 4th embodiment of the present disclosure. With reference to FIG. 5, the laser pumping device 4000 includes two pump-light emitters 400, a tube structure 410 and a laser gain material 420. Each of the pump-light emitters 400 is configured to emit a pump light 445 and has a pump axis (coinciding with the rod axis 428). The tube structure 410 is hollow-shaped and includes an accommodation space filled with cooling liquid 435 and two dielectric tubes 415, which are connected to face each other. Each of the dielectric tubes 415 includes an entrance surface 414 and a plurality of reflection surfaces 450. The number of the pump-light emitters 400 is two. Each of the pump-light emitters 400 is disposed adjacent to a corresponding entrance surface 414. The laser gain material 420 is installed in the accommodation space. Each of the dielectric tubes 415 is configured to receive the corresponding pump light 445 into the corresponding entrance surface 414, guide the corresponding pump light 445 along a corresponding one of the pump axes surrounded by the reflection surfaces 450, and concentrate the corresponding pump light 445 into the laser gain material 420.

In detail, the laser gain material 420 is a laser rod and has the rod axis 428, and each of the pump axes and the rod axis 428 are parallel to each other. Specifically, the rod axis 428 is the axis coinciding with the two pump axes, as shown in FIG. 5, and the laser pumping device 4000 has a longitudinal-pumping configuration. The number of the entrance surfaces 414 is two, and two ends of the laser gain material 420 is located adjacent to the two entrance surfaces 414, respectively. Specifically, the two pump-light emitters 400 are installed from the opposite ends of the laser gain material 420 to increase the pump absorption by the laser gain material (laser rod) 420.

Each of the pump-light emitters 400 is an LED plate including arrays of LED dies, and each of the pump axes is parallel to a normal direction of a surface of the corresponding pump-light emitter 400. For each of the dielectric tubes 415, oppositely faced two of the reflection surfaces 450 are wedged with a non-zero wedge angle α to concentrate the corresponding pump light 445 from the corresponding entrance surface 414 with a greater aperture toward the laser gain material 420 in a smaller aperture.

The accommodation space is filled with the following liquid 435, and a liquid inlet 433 and a liquid outlet 434 are connected to the tube structure 410. An air encloses the dielectric tubes 415, and a refractive index of the liquid 435 is greater than a refractive index of the air. Each of the reflection surfaces 450 located at the air-dielectric boundary can concentrate the pump light 445 toward the laser gain material 420 via total internal reflection subject to a nonzero numerical aperture calculated from Equation (6).

The liquid 435 is specifically a water, and a material of the dielectric tubes 415 can be glass or plastic. Each of the pump-light emitters 400 includes a blue or green light LED. The flowing liquid 435 is configured to concentrate the pump light toward the laser gain material 420, and at the same time remove the heat generated by the pump-light emitters 400 and the laser gain material 420.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A laser pumping device, comprising:
a pump-light emitter, configured to emit a pump light and having a pump axis;
a dielectric tube, being hollow-shaped and comprising an accommodation space, an entrance surface and a plurality of reflection surfaces, wherein the pump-light emitter is disposed adjacent to the entrance surface; and
a laser gain material, installed in the accommodation space;
wherein the dielectric tube is configured to receive the pump light into the entrance surface, guide the pump light along the pump axis surrounded by the reflection surfaces, and transmit the pump light into the laser gain material.

2. The laser pumping device of claim 1, wherein the pump-light emitter is an LED plate comprising arrays of LED dies, and the pump axis is parallel to a normal direction of a surface of the pump-light emitter.

3. The laser pumping device of claim 2, wherein the pump-light emitter comprises a blue-green light LED.

4. The laser pumping device of claim 1, wherein oppositely faced two of the reflection surfaces are parallel to each other and surround the pump axis.

5. The laser pumping device of claim 1, wherein oppositely faced two of the reflection surfaces are wedged with a wedge angle to concentrate the pump light from the entrance surface with a greater aperture toward the laser gain material in a smaller aperture.

6. The laser pumping device of claim 1, wherein the laser gain material is a laser rod and has a rod axis, and the pump axis and the rod axis are transverse to each other.

7. The laser pumping device of claim 1, wherein the accommodation space is filled with a liquid for cooling, an air encloses the dielectric tube, and a refractive index of the liquid is greater than a refractive index of the air.

8. The laser pumping device of claim 7, wherein the liquid is configured to remove a heat generated by the pump-light emitter and the laser gain material.

9. The laser pumping device of claim 7, wherein the liquid is a water, and a material of the dielectric tube is glass or plastic.

10. The laser pumping device of claim 7, wherein each of the reflection surfaces of the dielectric tube at a dielectric-air boundary provides total internal reflection to an incident pump light.

11. A laser pumping device, comprising:
a plurality of pump-light emitters, wherein each of the pump-light emitters is configured to emit a pump light and has a pump axis;
a tube structure, being hollow-shaped and comprising at least one accommodation space and at least one dielectric tube, wherein the dielectric tube comprises at least one entrance surface and a plurality of reflection surfaces, a number of the pump-light emitters and a number of the at least one entrance surface are plural and the same, and each of the pump-light emitters is disposed adjacent to a corresponding one of the entrance surfaces; and
a laser gain material, installed in the accommodation space;
wherein the dielectric tube is configured to receive at least one of the pump lights into the corresponding entrance surface, guide the pump light along a corresponding one of the pump axes surrounded by the reflection surfaces, and concentrate the pump light into the laser gain material.

12. The laser pumping device of claim 11, wherein the laser gain material is a laser rod and has a rod axis, and each of the pump axes and the rod axis are transverse to each other.

13. The laser pumping device of claim 12, wherein each of a number of the dielectric tube, the number of the pump-light emitters and the number of the entrance surfaces is more than two, the dielectric tubes are respectively extended along the pump axes of the pump-light emitters, and the pump axes intersect in the laser gain material.

14. The laser pumping device of claim 11, wherein the laser gain material is a laser rod and has a rod axis, each of the pump axes and the rod axis are parallel to each other, the number of the entrance surfaces is two, and two ends of the laser gain material is located adjacent to the two entrance surfaces, respectively.
